(19) United States
(12) Patent Application Publication
(10) Pub. No.: US 2010/0054420 A1
(43) Pub. Date: Mar. 4, 2010

(54) ADJUSTING DEVICE FOR BARRIER BLADE OF SCATTERED X-RAY

(76) Inventor: Ping Yuan, Beijing (CN)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/550,218

(22) Filed: Aug. 28, 2009

(30) Foreign Application Priority Data
Aug. 29, 2008 (CN) 200810130901.7

(51) Int. Cl. G21K 1/04

(52) U.S. Cl. 378/150

(57) ABSTRACT

An adjusting device for a barrier blade includes a barrier blade for limiting scattered X-ray of a tube and a base plate for mounting the barrier blade. The adjusting device also includes a barrier blade support and a drive unit, wherein said barrier blade support includes a sliding post; said barrier blade support is fixedly connected to the barrier blade and mounts the barrier blade in the opening of the base plate; and the drive unit controls and changes the path of the sliding post to cause the sliding post to drive the barrier blade support to make rectilinear movement on the base plate, thereby driving the barrier blade thereon to make rectilinear movement in the opening of the base plate. This adjusting device for a barrier blade of scattered X-ray has advantages of simple structure, small space, high reliability, and low cost.

### CROSS REFERENCE TO RELATED APPLICATIONS

This application claims the benefit of Chinese Patent Application No. 200810130901.7 filed Aug. 29, 2008, which is hereby incorporated by reference in its entirety.

### BACKGROUND OF THE INVENTION

The embodiments described herein relate to a medical X-ray apparatus, particularly to an adjusting device for adjusting and controlling a barrier blade of scattered X-ray.

X-ray produced outside the focus of a tube is called scattered X-ray. When the quantity of scattered X-ray reaches 15% of the quantity of the X-ray at the focus, the scattered X-ray will not only lower the sharpness and contrast of an image and affect exposure of tissue outside the main focus that is sensitive to radiation, but also blur the image of tissue in a diagnosis zone that has been collimated. The scattered X-ray does not have any benefit in medical diagnosis, which will not only lower the quality of the image, but also increase dosage of radiation of a patient.

Results from experiments and characteristics of tubes show that scattered X-ray mainly occurs in the front and back directions of the tubes (corresponding to the front and back directions of acollimator). Generally, a device with an adjustable lead plate is provided at the inlet of a collimator (outlet of the tube) for limiting scattered X-ray. However, the adjusting device in the prior technical solution generally is relatively complicated in structure and relatively high in cost.

### BRIEF DESCRIPTION OF THE INVENTION

One aspect provides an adjusting device for a barrier blade of scattered X-ray that limits the scattered X-ray of a tube entering the beam limiting device under the tube. This adjusting device has advantages of being compact in structure, easy to control and low in cost.

An adjusting device for barrier blade provided by this invention comprises a barrier blade for limiting scattered X-ray of a tube and a base plate for mounting the barrier blade. The base plate includes an opening through which X-ray of the X-ray tube passes, and said barrier blade adjusts and controls the X-ray passing through said opening of the base plate by movement. The adjusting device is characterized in that it further comprises a barrier blade support and a drive unit, wherein said barrier blade support includes a sliding post; said barrier blade support is fixedly connected to the barrier blade and mounts the barrier blade in the opening of the base plate; and the drive unit controls and changes the path of the sliding post to cause the sliding post to drive the barrier blade support to make rectilinear movement on the base plate, thereby driving the barrier blade thereon to make rectilinear movement in the opening of the base plate.

A rectilinear sliding slot is provided in said base plate, the extension line of said rectilinear sliding slot passing through the center of the opening of the base plate; and said barrier blade support makes rectilinear movement along said rectilinear sliding slot.

Said barrier blade support comprises a support bar including transverse bar capable of sliding in the rectilinear sliding slot of the base plate and an oblique fixation plate extending obliquely upward along one end of the transverse bar for fixing the barrier blade, said sliding post being fixedly connected to the transverse bar.

A screw-screw-threaded hole is opened in another end of the transverse bar. Said sliding post is a/screw-screw-threaded post with a screw cap for fitting said screw-screw-threaded hole. A through hole is opened in the rectilinear sliding slot of the base plate for the sliding post to pass through to fit the screw-threaded hole.

Said drive unit comprises a chassis and a drive means for driving said chassis to rotate. An opening is opened in the center of said chassis corresponding to the center of the opening of the base plate. A non-uniform diameter curvilinear sliding slot is provided along the periphery of the opening of the chassis. One end of said sliding post is located within the non-uniform diameter curvilinear sliding slot of said chassis, and the screw cap of said sliding post is held within the non-uniform diameter curvilinear sliding slot of said chassis.

Said non-uniform diameter curvilinear sliding slot of said chassis is an elliptical sliding slot.

Said base plate is a circular disc with the opening thereof in a square shape.

Said barrier blade is a trapezoidal blade with the upper part smaller than the lower part.

Said chassis is a circular disc with the opening thereof in a circular shape.

Said drive control means is an electrical powered gear.

In some embodiments, the rotation of the elliptical curvilinear sliding slot is controlled by a drive unit so as to change the position of the sliding post in the slot to cause the sliding post to drive the scattered X-ray barrier blade support to make rectilinear movement to drive the barrier blade thereon to make rectilinear movement, thereby limiting unnecessary scattered X-ray of the tube passing through the opening of the base plate to reach the beam limiting device under the tube. The adjusting device for the scattered X-ray barrier blade of this invention has a simple structure, takes small space, has a high reliability, and costs low.

### BRIEF DESCRIPTION OF THE DRAWINGS

FIGS. 1A and 1B are three-dimensional exploded schematic diagrams of the adjusting device for a barrier blade of the present invention;

FIG. 2 is a schematic diagram of the adjusting device for a barrier blade of this invention after assembled;

FIGS. 3A and 3B are diagrams showing the barrier blade driven in an elliptical curve; and

FIGS. 4A and 4B are schematic diagrams indicating the barrier blade respectively in the largest FOV position and the smallest FOV position.

### DETAILED DESCRIPTION OF THE INVENTION

An embodiment of this invention will be hereinafter described with reference to the accompanying figures. However, the present invention is not limited to the embodiment.

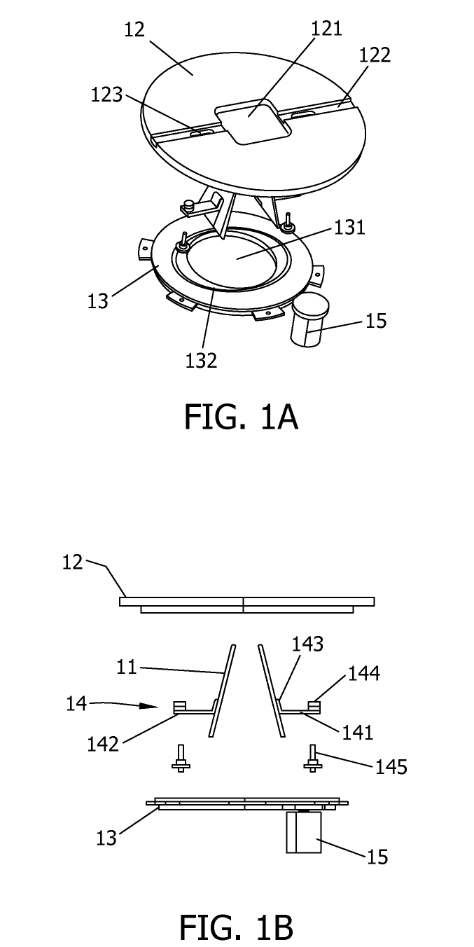

FIGS. 1A and 1B show exploded schematic diagrams of the adjusting device for a barrier blade of this invention, which comprises a barrier blade 11, a base plate 12 and a chassis 13 as well as a drive means 15 for driving the chassis 13 to rotate. An opening 121 is provided in the center of the base plate 12 for X-ray to pass through, and a rectilinear sliding slot 122 is provided along a central symmetric line of the base plate 12, the slot 122 being provided with a through hole 123. In this embodiment, the base plate 12 is in a circular disc shape with the opening 121 thereof in a square shape, and the number of the rectilinear sliding slot 122 is two.

The barrier blade 11 is mounted on the base plate 12 for limiting unnecessary scattered X-ray passing through the opening 121 of the base plate 12. Generally four barrier blades, in a trapezoid shape with the upper part narrower than the lower part so as to be consistent with the fan-shaped X-ray beam emitting from the X-ray tube, are mounted on the base plate 12, opposite to each other in a group of two. The barrier blades may be fully adjustable, or may include a part that is stationary and nonadjustable. In this embodiment, only a pair of adjustable barrier blades 11 is to be described. The lower parts of the adjustable barrier blades 11 pass through the opening 121 of the base plate 12 and are mounted at the opening 121 of the base plate 12 by means of barrier blade supports 14. The barrier blade support 14 causes the barrier blades 11 to incline inward relatively.

The barrier blade support 14 includes a support bar 142 and a sliding post 145. The support bar 142 includes a transverse bar 141 capable of sliding in the rectilinear sliding slot 122 of the base plate 12 and an oblique fixation plate 143 extending obliquely upward along one end of the transverse bar 141 for fixing the barrier blade 11, and a screw-threaded hole 144 is opened in another end of the transverse bar 141. Said sliding post 145 is a screw-threaded post with a screw cap for fitting the screw-threaded hole 144 in the support bar 142.

An opening 131 is opened in the center of the chassis 13 for X-ray to pass through. An elliptical sliding slot 132 is provided in the periphery of the opening 131 for the sliding post 145 to slide therealong. The chassis 13 is in a circular disc shape, and the opening 131 is a circular opening.

The drive means 15 is used for driving the chassis 13 to rotate, which may be an independent electrical powered gear system, or may be a motor system for the rectangular beam limiting blades set.

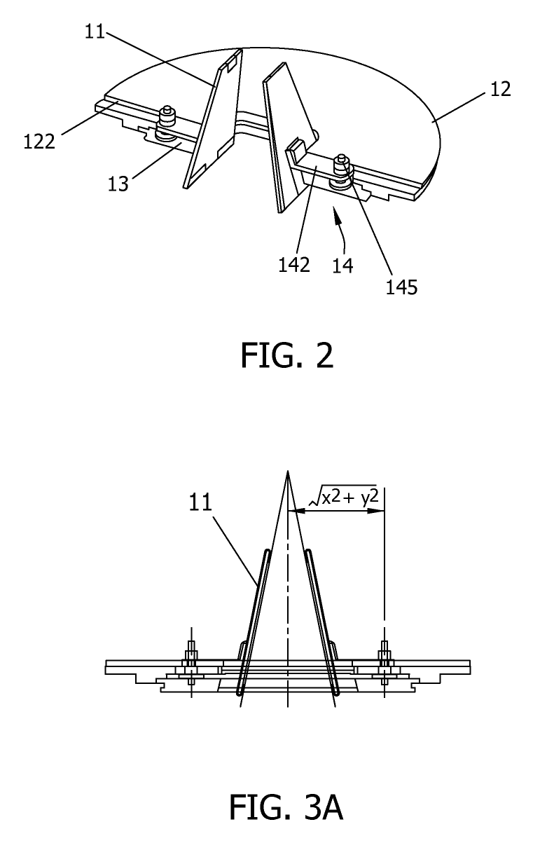

When mounting, the sliding post 145 is fit in the elliptical sliding slot 132 of the chassis 13 with the screw cap thereof in the elliptical sliding slot 132 to prevent the sliding post 145 from sliding out the elliptical sliding slot 132; the barrier blade 11 is fixed onto the oblique fixation plate 143 of the support bar 142; the barrier blade 11 fixed with the support bar 142 is passed through the opening of the base plate 11 with the support bar 142 placed in the rectilinear sliding slot 122 of the base plate 11 and with the screw-threaded hole 144 in the support bar 142 fallen into the range of the through hole 123 of the rectilinear sliding slot 122; and finally the sliding post 145 is passed through the through hole 123 of the base plate 12 to fit into the screw-threaded hole 144 to accomplish the assembling process. FIG. 2 is a schematic diagram of the adjusting device for a barrier blade of this invention after assembled.

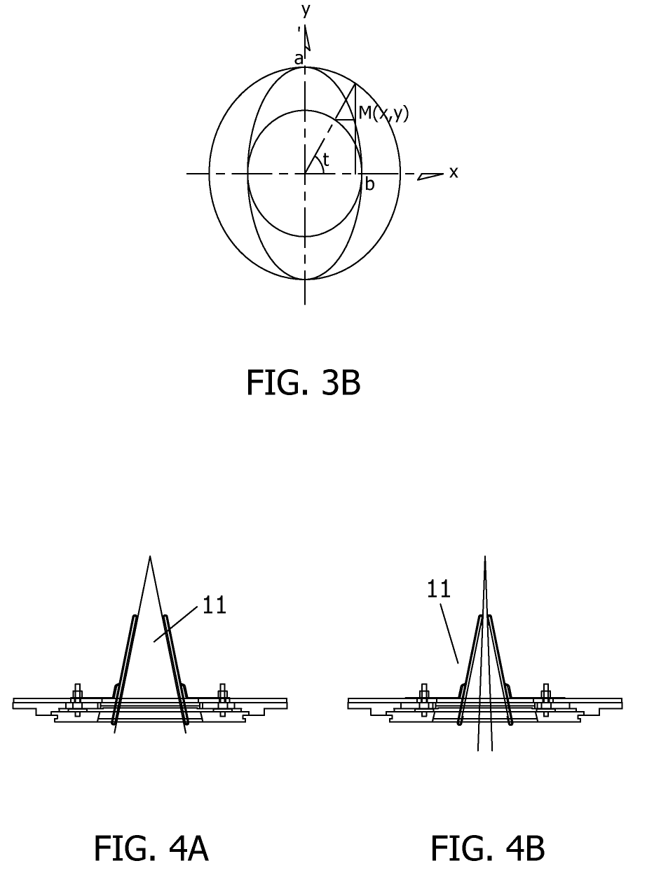

The drive means 15 drives the chassis 13 to rotate and the sliding post 145 slides in the elliptical sliding slot 132. The change of the track of the elliptical sliding slot changes the distance between the sliding posts 145, thereby driving the support bar 142 connected therewith to make rectilinear movement along the rectilinear sliding slot 123 in the base plate 12. And the forward and backward movement of the support bar 142 drives the barrier blade 11 fixed therewith to move, thereby achieving adjustment of opening distance between barrier blades 11. The characteristic of an ellipse makes the rectilinear movement of the barrier blade easy to control. Referring to FIGS. 3A and 3B, the position of the barrier blade 11 on the rectilinear sliding slot 122 is determined by \sqrt{x²+y²}, wherein x, y are calculated by the following set of formulas:

x=a*cos t

y=b*sin t

wherein a is the minor axis of the ellipse; b is the major axis of the ellipse; and t is the angle that the chassis 13 has rotated through.

Where \sqrt{x²+y²} equals to a, the barrier blade 11 is in position of the largest FOV (Field of view), as shown in FIG. 4A; and where \sqrt{x²+y²} equals to b, the barrier blade 11 is in the position of the smallest FOV, as shown in FIG. 4B.

Of course, it is also possible to provide other non-uniform diameter curvilinear sliding slots in the chassis 13 to change the position of the sliding post 145 so as to drive the barrier blade 11 to move.

1. An adjusting device for a barrier blade, said adjusting device comprising:
a barrier blade configured to limit scattered X-ray of a tube;
a base plate for mounting said barrier blade, said base plate comprising an opening through which X-ray of the tube passes, said barrier blade configured to adjust and control the X-ray passing through said base plate opening by movement;
a barrier blade support comprising a sliding post, said barrier blade support fixedly connected to said barrier blade and and configured to mount said barrier blade in said base plate opening; and
a drive unit configured to control and change a path of said sliding post to cause said sliding post to drive said barrier blade support to make rectilinear movement on said base plate, thereby driving said barrier blade thereon to make rectilinear movement in said base plate opening.

2. The adjusting device for a barrier blade according to claim 1, wherein said base plate further comprises a rectilinear sliding slot, an extension line of said rectilinear sliding slot passing through a center of said base plate opening, and wherein said barrier blade support is configured to move rectilinearly along said rectilinear sliding slot.

3. The adjusting device for a barrier blade according to claim 2, wherein said barrier blade support comprises a support bar comprising a transverse bar capable of sliding within said rectilinear sliding slot and an oblique fixation plate extending obliquely upward along a first end of said transverse bar for fixing said barrier blade, said sliding post being fixedly connected to said transverse bar.

4. The adjusting device for a barrier blade according to claim 3, wherein:
said transverse bar comprises a screw-screw-threaded hole in a second end;
said sliding post comprises a screw-screw-threaded post with a screw cap for fitting said screw-screw-threaded hole; and
said rectilinear sliding slot comprises a through hole for said sliding post to pass through to fit said screw-screw-threaded hole.

5. The adjusting device for a barrier blade according to claim 4, wherein said drive unit comprises a chassis and a drive means configured to drive rotation of said; chassis, an opening is opened in a center of said chassis corresponding to the center of said base plate opening, a non-uniform diameter curvilinear sliding slot is provided along the periphery of said chassis opening, a first end of said sliding post is located within said non-uniform diameter curvilinear sliding slot, and said screw cap is held within said non-uniform diameter curvilinear sliding slot of said chassis.

6. The adjusting device for a barrier blade according to claim 5, wherein said non-uniform diameter curvilinear sliding slot of said chassis comprises an elliptical sliding slot.

7. The adjusting device for a barrier blade according to claim 6, wherein said chassis comprises a circular disc with the opening thereof in a circular shape.

8. The adjusting device for a barrier blade according to claim 5, wherein said drive control means comprises an electrical powered gear.

9. The adjusting device for a barrier blade according to claim 8, wherein said barrier blade comprises a trapezoidal blade with an upper part smaller than a lower part.

10. The adjusting device for a barrier blade according to claim 9, wherein said base plate comprises a circular disc with the opening thereof in a square shape.

11. A method for limiting scattered X-rays within an X-ray tube, said method comprising:
coupling a barrier blade to a base plate that includes an opening through which the X-rays pass;
coupling a barrier blade support to the barrier blade within the base plate opening, wherein the barrier blade support includes a sliding post;
moving the sliding post using a drive unit in order to cause the sliding post to drive the barrier blade support in a rectilinear movement along the base plate, thereby driving the barrier blade in a rectilinear movement within the base plate opening.

12. An adjusting device for a barrier blade, said adjusting device comprising:
a barrier blade configured to limit scattered X-ray of a tube;
a base plate for mounting said barrier blade, said base plate comprising an opening through which X-ray of the tube passes, said barrier blade configured to adjust and control the X-ray passing through said base plate opening by movement, wherein said base plate further comprises a rectilinear sliding slot, an extension line of said rectilinear sliding slot passing through a center of said base plate opening, and wherein said barrier blade support is configured to move rectilinearly along said rectilinear sliding slot;
a barrier blade support comprising a sliding post, said barrier blade support fixedly connected to said barrier blade and configured to mount said barrier blade in said base plate opening; and
a drive unit configured to control and change a path of said sliding post to cause said sliding post to drive said barrier blade support to make rectilinear movement on said base plate, thereby driving said barrier blade thereon to make rectilinear movement in said base plate opening.

13. The adjusting device for a barrier blade according to claim 12, wherein said barrier blade support comprises a support bar comprising a transverse bar capable of sliding within said rectilinear sliding slot and an oblique fixation plate extending obliquely upward along a first end of said transverse bar for fixing said barrier blade, said sliding post being fixedly connected to said transverse bar.

14. The adjusting device for a barrier blade according to claim 13, wherein:
said transverse bar comprises a screw-screw-threaded hole in a second end;
said sliding post comprises a screw-screw-threaded post with a screw cap for fitting said screw-screw-threaded hole; and
said rectilinear sliding slot comprises a through hole for said sliding post to pass through to fit aid screw-screw-threaded hole.

15. The adjusting device for a barrier blade according to claim 14, wherein said drive unit comprises a chassis and a drive means configured to drive rotation of said chassis, an opening is opened in a center of said chassis corresponding to the center of said base plate opening, a non-uniform diameter curvilinear sliding slot is provided along the periphery of said chassis opening, a first end of said sliding post is located within said non-uniform diameter curvilinear sliding slot, and said screw cap is held within said non-uniform diameter curvilinear sliding slot of said chassis.

16. The adjusting device for a barrier blade according to claim 5, wherein said non-uniform diameter curvilinear sliding slot of said chassis comprises an elliptical sliding slot.

17. The adjusting device for a barrier blade according to claim 6, wherein said chassis comprises a circular disc with the opening thereof in a circular shape.

18. The adjusting device for a barrier blade according to claim 5, wherein said drive control means comprises an electrical powered gear.

19. The adjusting device for a barrier blade according to claim 8, wherein said barrier blade comprises a trapezoidal blade with an upper part smaller than a lower part.

20. The adjusting device for a barrier blade according to claim 9, wherein said base plate comprises a circular disc with the opening thereof in a square shape.
